(19) United States
(12) Patent Application Publication
(10) Pub. No.: US 2006/0218832 A1
(43) Pub. Date: Oct. 5, 2006

(54) Lighted-sign stand

(76) Inventor: Guo Feng Chu, Hong Kong SAR (CN)

Correspondence Address: LEYDIG VOIT & MAYER, LTD, 700 THIRTEENTH ST. NW, SUITE 300, WASHINGTON, DC, 20005-3960, US

(21) Appl. No.: 11/335,839

(22) Filed: Jan. 20, 2006

(30) Foreign Application Priority Data
Jan. 21, 2005 (CN) 20052003834.4

(51) Int. Cl. G09F 13/04

(52) U.S. Cl. 40/564

(57) ABSTRACT

A lighted-sign stand comprises a body having a base supporting a sign on a horizontal surface. The body of the stand has a sign panel and a frame for holding the sign. The stand further comprises a light source and a control circuit. The control circuit having a sensor at the base of the stand for turning the light source off and on, respectively, turning the light source off when the base is supporting the sign on a horizontal surface and turning the light source on when the base is lifted off the horizontal surface.

### FIELD OF THE INVENTION

The present invention relates to a lighted-sign stand for supporting a sign on a horizontal surface.

### BACKGROUND TO THE INVENTION

Sign stands have been widely used. It is common to display information on these stands. However, there are occasions where lights are dimmed to create a relaxing and more comfortable atmosphere rendering the displayed information difficult to read.

Lighted advertisement stands are used to overcome the problem. However, the light source of the advertisement stand remains connected to the power supply resulting continuous illumination, which can be disturbing.

### OBJECT OF THE INVENTION

It is an object of the present invention to overcome or ameliorate the above problem and/or more generally to provide a lighted-sign stand in which the light source control circuit is controlled by the reader of the displayed information.

### SUMMARY OF THE INVENTION

There is disclosed herein a lighted-sign stand comprising a body having a foot for supporting the base on a horizontal surface, a sign panel on the base, a light source for illuminating the sign panel, and a control circuit having a sensor at the base for turning the light source off and on, respectively turning the light source off when the base is supporting the sign on a horizontal surface and turning the light source on when the base is lifted off the horizontal surface.

Preferably, the stand comprises a second sign panel on the base and joining the sign panel at a top edge forming a tent-shaped housing enclosing the light source.

Preferably, the control circuit includes an override-switch for turning the light source off or on.

Preferably, the control circuit includes an energy source and electrical conductors connecting the energy source, light source and sensor in a series electrical circuit.

Preferably, the light source is a light emitting diode.

Preferably, the control circuit includes an energy source, a resistor, and electrical conductors connecting the energy source, resistor, light source and sensor in a series electrical circuit.

Preferably, the sensor is one of a micro-motion switch, a silica gel switch, a swing rod switch, a push rod switch, a light touch switch, a press button switch and a ship-shaped switch.

Preferably, the sign panel comprises a light transmissive panel and a frame around the panel for holding a sign to the panel.

Further aspects of the invention will become apparent from the following description.

### BRIEF DESCRIPTION OF THE DRAWING

An embodiment of the present invention will now be described by way of example only and with reference to the accompanying figures in which:

FIG. 1 is a perspective view of a lighted-sign stand,

FIG. 2 is a side view of the stand,

FIG. 3 is a sectional side view of the stand base area, and

FIG. 4 is a circuit diagram of a control circuit of the lighted-sign stand.

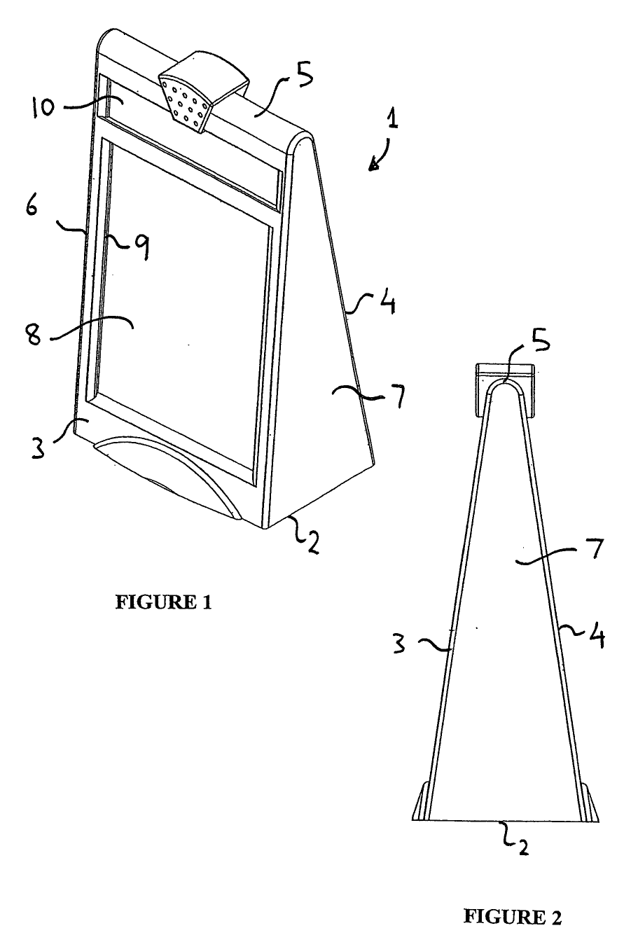

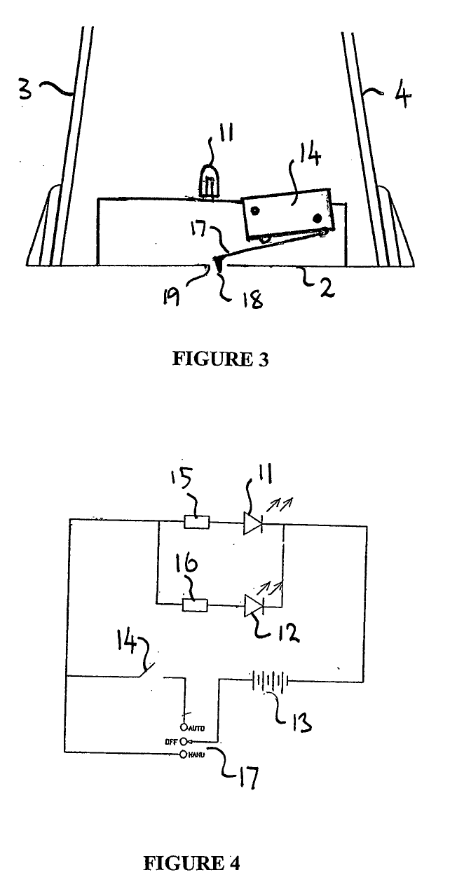

### DESCRIPTION OF THE PREFERRED EMBODIMENT

In the drawings there is detected a lighted-sign stand 1 having a foot or base 2 for supporting a tent or ‘A’ shaped housing on a horizontal surface such as a table or counter top. The “A” shaped housing has two sign panels 3, 4 extend from long edges of the base 2 to an apex 5 and two triangular shaped side panels 6 and 7. Each sign panel 3, 4 comprises a light transmissive window 8 surrounded by a frame 9 having an upper slot 10 into which a light transmissive printed sign can slide for positioning in front of the window 8. Within the sign housing there is a light source consisting of two Light Emitting Diodes (LED) 11, 12 for illuminating the transparent window 8 in the sign panels 3, 4.

A control circuit in the housing has an energy source, in the form of battery 13, and a sensor, in the form of switch 14, in series with the LEDs 11, 12 for turning the LEDs 11, 12 on and off. Two resistors 15, 16 in series with the LEDs 11, 12 provided the correct operation voltage for the LEDs. The switch 14 has an activation lever 17 with a button 18 extending beyond the base 2 through an aperture 19 so that when the sign stand is supported on a flat surface the lever 17 moves to open the switch and turn the light source off. When the sign is lifted off the horizontal surface the lever 17 moves to close the switch 14 and turn on the light source to illuminate the sign. In this way, the sign stand may be used on a dining table in, for example, a restaurant where the light source is off so as not to disturb diners during the normal course of events, but when a diner picks up the sign stand for closer inspection of the sign the light source turns on to illuminate the sign.

The control circuit also includes an over-ride control switch 17 having off, manual and auto positions. The off position disables the control circuit so that the light source will not illuminate when the sign is lifted off the horizontal surface. The manual position illuminates the sign at all times regardless of its location on or off a horizontal surface and the auto position operates the sign in the manner previously mentioned.

It should be appreciated that modifications and/or alternations obvious to those skilled in the art are not to be considered as beyond the scope of the present invention. For example, the sensor can be any one of a micro-motion switch, a silica gel switch, a swing rod switch, a push rod switch, a light touch switch, a press button switch or a ship-shaped switch arranged to detect when the sign stand is picked up.

The preferred embodiment has two sign panels connected at the top edge to form a tent-shaped housing. In an alternative embodiment two or more sign panels can be connected to form a housing of different shapes, or the sign stand may have only one sign panel.

The preferred embodiment has a light source at the base enclosed inside the tent-shaped housing. In an alternative embodiment the light source can be situated at the top of the housing.

What is claimed is:

1. A lighted-sign stand comprising:
a base having a foot for supporting the base on a horizontal surface,
a sign panel on the base,
a light source for illuminating the sign panel, and
a control circuit having a sensor at the base for turning the light source off and on, respectively turning the light source off when the base is supporting the sign on a horizontal surface and turning the light source on when the base is lifted off the horizontal surface.

2. The stand of claim 1 comprising a second sign panel on the base and joining the sign panel at a top edge forming a tent-shaped housing enclosing the light source.

3. The stand of claim 1 wherein the control circuit includes an override-switch for turning the light source off or on.

4. The stand of claim 1 wherein the control circuit includes a energy source and electrical conductors connecting the energy source, light source and sensor in a series electrical circuit.

5. The stand of claim 1 wherein the light source is a light emitting diode.

6. The stand of claim 5 wherein the control circuit includes an energy source, a resistor, and electrical conductors connecting the energy source, resistor, light source and sensor in a series electrical circuit.

7. The stand of claim 1 wherein the sensor is one of a micro-motion switch, a silica gel switch, a swing rod switch, a push rod switch, a light touch switch, a press button switch or a ship-shaped switch.

8. The stand of claim 1 wherein the sign panel comprises a light transmissive panel and a frame around the panel for holding a sign to the panel.

9. A lighted-sign stand comprising:
a body having a sign panel and a base for supporting the stand on a horizontal surface,
a light source for illuminating the sign panel, and
a switch at the base for turning the light source off and on, respectively turning the light source off when the base is supporting the sign on a horizontal surface and turning the light source on when the base is lifted off the horizontal surface.

10. A lighted-sign stand comprising:
a tent-shaped housing having a light transmissive sign panel and a base for supporting the housing on a horizontal surface,
a light source located in the housing for illuminating the sign panel, and
a control circuit having a sensor at the base for turning the light source off and on, respectively turning the light source off when the base is supporting the sign on a horizontal surface and turning the light source on when the base is lifted off the horizontal surface.
